(19) United States
(12) Patent Application Publication
(10) Pub. No.: US 2008/0020628 A1
(43) Pub. Date: Jan. 24, 2008

(54) Speaker Cable Plug and Speaker Terminal for Receiving Such Plug, and Speaker Terminal System Using Such Plug and Terminal

(75) Inventor: Eiji Kikuchi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIPPON DICS CO., TOKYO (JP)

(21) Appl. No.: 10/565,681

(22) PCT Filed: Mar. 2, 2004
(86) PCT No.: PCT/JP04/02549

§ 371 Date: Mar. 9, 2007

(30) Foreign Application Priority Data
Jul. 24, 2003 (JP) 2003-279148

(51) Int. Cl. H01R 13/40

(52) U.S. Cl. 439/441

(57) ABSTRACT

To provide a speaker cable plug which is high in performance and easy to use, a speaker terminal for connection to such plug, and a speaker terminal system using such plug and terminal as a set. A plug main body 1 which is internally hollow and formed with a terminal insertion port 2 for positive and negative electrodes in the front surface, and in the rear surface with a cable insertion port 3 corresponding to both electrodes, and which internally has terminal holding tongue pieces 5a, 5b for holding the speaker terminal inserted through the terminal insertion port 2 from both sides of the speaker terminal by springiness, and cable holding tongue pieces 6a, 6b connected to the terminal holding tongue pieces 5a, 5b for holding the lead wires of the speaker cable for positive and negative electrodes inserted through the cable insertion port 3 from both sides the lead wires by springiness, wherein an operating piece 7 for expanding the cable holding parts of the cable holding tongue pieces 6a, 6b for both electrodes is formed so that each cable holding part can be expanded by a separate operating piece 7.

### TECHNICAL FIELD

This invention relates to a speaker cable plug to be able to connect speaker cables of each channel to a speaker terminal for multiple channels easily and correctly, the speaker terminal inserted by the speaker cable plug, and a speaker terminal system comprising the speaker cable plug and the speaker terminal in an audio system such as home theater system.

### BACKGROUND

Recently, home theater systems, in which the force or the realistic sensation of cinemas can be experienced at home as if in a theater, is becoming popular. And the home theater systems will become further popular rapidly in the future since they can provide enjoyment of image and acoustics, which cannot be obtained from a conventional audio system, by combining the image presented in a big view with the fine, realistic and forceful acoustics corresponding to the image that is emitted from speakers of multiple channels for example 5.1 channel.

However, in order to produce the realistic acoustics, it is needed to use a large number of speakers, large and small for multiple channels, in the home theater systems, and in that case, if a type of connection for each speaker is a terminal and the like in a conventional lever type, there is a problem that is easy to make misconnections, since the connecting operation is not only complicated but also is needed for the multiple channels and the large number of speakers.

Recently, in the audio system using a large number of speakers, large and small for the multiple channels such as the home theater system, a speaker cable plug which is devised to connect speaker cables correctly for connecting the speaker terminals for speakers and amplifier, and not to make misconnections thereof has been proposed in the Patent Literature 1.

However, it didn't achieve sufficient effect yet. The applicant of the invention also proposed previously a speaker cable plug and a speaker terminal being able to connect a speaker cable easily and correctly without producing misconnections in patent application JP-2003-279148.

(Patent Literature 1.: U.S. Pat. No. 3,435,132)

### SUMMARY OF THE INVENTION

It is a problem for this invention to further improve the speaker cable plug and the speaker terminal for connecting the speaker cable plug proposed previously by the applicant of this invention and to provide a speaker cable plug and a speaker terminal with higher performance and better convenience for use, and a speaker terminal system using the speaker cable plug and the speaker terminal in a set.

A speaker cable plug in this invention achieved to resolve the said problem comprises a plug main body is internally hollow and formed with a terminal insertion port for positive and negative electrodes in the front surface, and with a cable insertion port corresponding to the both electrodes in the rear surface, and which internally has terminal holding tongue pieces for holding a speaker terminal inserted through the terminal insertion port from both sides of the speaker terminal by springiness respectively, and cable holding part connected to the terminal holding tongue pieces respectively for holding the lead wires of the speaker cable for positive and negative electrodes inserted through the cable insertion port from both sides of the lead wires by springiness,
wherein an operating piece for expanding the cable holding parts of the cable holding tongue pieces for both electrodes is formed so that each cable holding part can be expanded by a separate operating piece independently.

The plug main body of the speaker cable plug of this invention described above is configured with a locking lever having a locking part, on external surface of the side configured with the terminal insertion port, which is pressed bend at an inlet of the terminal port and locked into the inlet of the terminal port due to its rebounding by springiness as passed the inlet, when the plug main body is inserted into a terminal port of an amplifier having a speaker terminal internally.

In addition, the plug main body comprises terminal insertion ports and cable insertion ports for at least two channels and internal configuration each configured between the terminal insertion ports and the cable insertion ports for a respective channel among the channels, and the terminal insertion ports, the cable insertion ports and the internal constructions for at least the two channels are formed as a whole.

Further, it is sufficient to configure one locking lever in the plug for at least the two channels. In addition, no polarity confusion will occur during the insertion of the speaker cable plug into a terminal port, of which face shape is formed in the cross-section shape same as the front cross-section shape of the plug, owing to the left-right or up-down asymmetric front cross-section shape of the plug main body.

In addition, in this invention, the locking lever of claim 2 is configured by one in the speaker cable plug for multiple channels which is formed as a whole and has cable insertion ports and terminal insertion ports for at least two channels and internal constructions for holding and connecting each inserted cable and terminal.

On the other hand, in the invention, the speaker terminal inserted by the speaker cable plug of the invention described above comprises terminal ports in the form of a straight depression towards in-depth end along a opening portion which forms an opening, on the front-end surface of the speaker terminal, in the cross-section shape approximately same to the front cross-section peripheral shape of the plug main body which is formed as a whole so as to be able to connect with inserted speaker cables of at least two channels, and contacting pieces of the terminals for both electrodes for a speaker of each channel, which are configured respectively, in a approximately horizontal attitude towards front end-surface of the opening portion, on the in-depth inner-wall surface of the terminal ports, and wherein locking convex parts for hooking and holding locking parts of locking levers of an inserted plug main body are formed at the opening edge of the front-end of the terminal ports.

Herein, by disposing the contacting pieces of the terminals for both electrodes for the speaker formed with a difference in distance relative to the front end-surface of the opening portion between the leading edges thereof, the noise at connecting time can be avoided, and a test finger also can be prevented from contacting the contacting pieces in combining with the opening shape of the opening portion.

In the speaker terminal of the invention described above, terminal ports for paired channels among multiple channels can be configured space-effectively and the area of the speaker terminal for speaker-connection can be reduced by forming the terminal ports for the paired channels among the multiple channels in symmetric configurations.

In addition, the external surfaces of the front-ends of the terminal ports for the various channels are colored up to separate from each other, thereby avoiding misconnection. Further, a shield board is configured on the front surface excluding those of the terminal ports, as a countermeasure for noise.

The speaker cable plug of this invention and the speaker terminal of the invention can connect speaker cables easily and correctly without misconnection even if there are multiple channels in a audio system using respective speakers for multiple channels since the speaker cable plug adopts a configuration enabling the cables to be inserted into or drawn out with one touch operation and the speaker terminal also adopts a configuration enabling the plug of the invention to be inserted into or drawn out with one touch operation.

### BRIEF DESCRIPTION OF THE DRAWINGS

Next, preferred embodiments of the speaker cable plug, the speaker terminal and the speaker terminal system of this invention comprising them will be described with reference to the accompanying drawings.

FIG. 1 is a front view showing an example of a speaker cable plug for one channel according to the invention.

FIG. 2 is a bottom view of the plug of FIG. 1.

FIG. 3 is a plane view of the plug of FIG. 1.

FIG. 4 is a view of the plug along the line Y-Y of FIG. 2.

FIG. 5 is a front view of an example of a speaker cable plug for 2 channels according to the invention.

FIG. 6 is a bottom view of the plug of FIG. 5.

FIG. 7 is a plane view of the plug of FIG. 5.

FIG. 8 is a view of the plug along line Z-Z of FIG. 6.

FIG. 9 is an enlarged cross-section view along line X-X of FIG. 5 for illuminating the internal configuration of the speaker cable plug of the invention of FIG. 1˜FIG. 8.

FIG. 10 is an enlarged cross-section view for illuminating the state in which a speaker cable is connected to the plug of the invention of FIG. 9.

FIG. 11 is a perspective view showing an example of a speaker terminal for one channel according to the invention.

FIG. 12 is a front view of the speaker terminal of FIG. 11.

FIG. 13 is a cross-section view of the speaker terminal along the line A-A of FIG. 11.

FIG. 14 is a front view showing an example of the speaker terminal for 6 channels according to the invention.

FIG. 15 is a side cross-section view showing the connection state of the plug of the invention and the speaker terminal of the invention of FIG. 14.

FIG. 16 is a perspective view showing the relation between the speaker cable plug of the invention of FIG. 1 and FIG. 5 and the speaker terminal of the invention of FIG. 14.

FIG. 17 is a perspective view of a speaker cable plug of which the plug main body for 3 channels is formed as a whole according to the invention as seen from the inside.

FIG. 18 is a perspective view for illustrating examples of a speaker cable plug for 3 channels of which the plug main body is form as a whole according to the invention and a speaker terminal for 6 channels according to the invention.

FIG. 19 is an enlarged cross-section view showing one configuration example in the plug of the invention of FIG. 18.

FIG. 20 is an enlarged cross-section view showing another configuration example in the plug of the invention of FIG. 18.

### DETAILED DESCRIPTION OF PREFERRED EMBODIMENTS

Firstly, the current home theater system called 5.1 channel is composed of a displayed view by a liquid crystal panel or a CRT etc., a device for driving the view, which is a DVD (Digital Versatile Disc) player here, two front speakers for left channel and right channel and two rear speakers for left channel and right channel, which are configured respectively at four corners of a listening room, one center speaker configured in front of a listener, and one subwoofer configured at a suitable location. So, the speakers should have 6 channels formally, and the input terminal of each speaker should be connected to an output speaker terminal of an amplifier of the player via a speaker cable respectively.

In connecting the speakers of 6 channels above with speaker terminals of equipment such as DVD player for driving the speakers, it is necessary to pay attention not to confuse the polarities of each speaker while connecting it and connect the speaker terminals for the various channels with specified terminals respectively without confusing them among the channels. However, as described above, no speaker terminal system being able to connect easily and correctly without leading to these confusions has been found previously.

Further, it is necessary to connect a cable plug with speaker cables for connecting the speakers to the speaker terminals of the amplifier for various channels after adjusting the length of each cable in advance since the lengths of the speaker cables are differentiated by the size of the listening room and the configuration locations of the speakers. However, as described above, no speaker cable plug being able to connect with various cables or separate from them easily and reliably is provided sufficiently.

Consequently, the invention provides a speaker cable plug, a speaker terminal for connecting with the speaker cable plug, and a speaker terminal system comprising the speaker cable plug and the speaker terminal, which are accomplished for resolving the problems described above. Next, description will be given with respect to them in sequence.

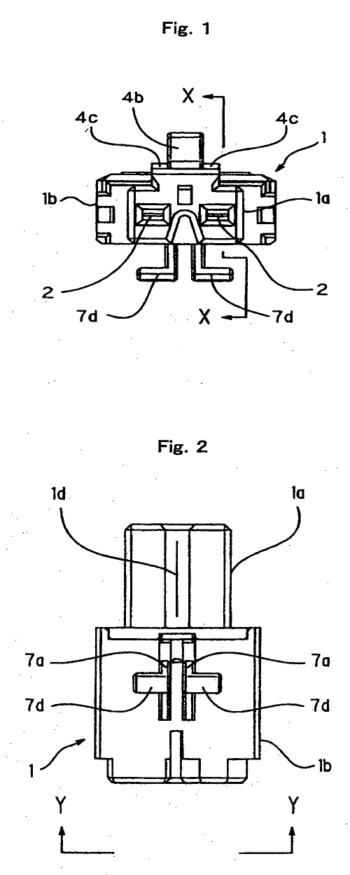

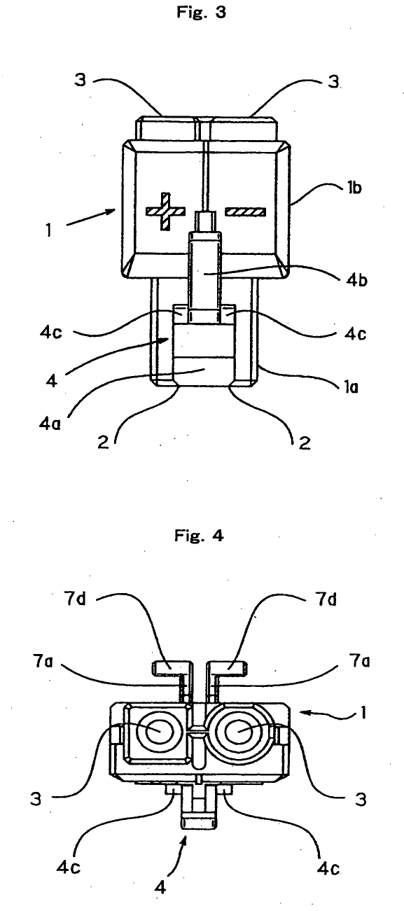

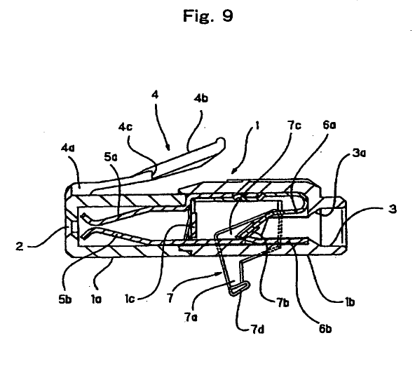

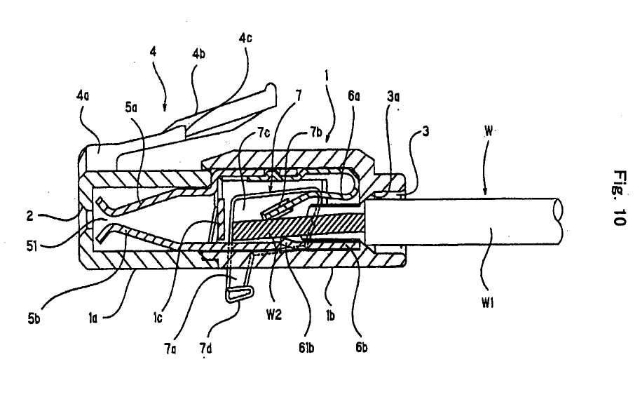

Firstly, the speaker cable plug according to the invention is described using FIG. 1 to FIG. 4, FIG. 9 and FIG. 10. The plug main body 1 is formed in parallel with two terminal insertion ports 2 (only one is shown in FIG. 9 and FIG. 10) on the left and right of the front surface thereof (with reference to FIG. 1, which is left side in FIG. 9 and FIG. 10), and two cable insertion ports 3 (only one is shown in FIG. 9 and FIG. 10) corresponding to the two terminal insertion ports 2 on the left and right of the rear surface thereof (with reference to FIG. 4, which is right side in FIG. 9 and FIG. 10).

The plug main body 1 is internally hollow and the front cross-section thereof is approximately a quadrangle. Only the constructions of the two terminal insertion ports 2 and the two cable insertion ports 3 are described, but other terminal insertion ports or cable insertion ports with the same construction can be comprised in the invention.

In the plug main body 1, the cable insertion ports 3 is formed to a narrow inlet 3a narrowed in the shape of a taper at the in-depth side of its inlet and the covering section w1 of the cable w can be inserted into the inside of the plug main body 1 (with reference to FIG. 10). Moreover, as shown in FIG. 9 and FIG. 10, the plug main body 1 has a front-back two-piece construction in which the plug front portion 1a and the plug back portion 1b are jointed together as shown in FIG. 9 and FIG. 10. But it is not limited to the construction form shown, for example, a left-right two-piece construction and other constructions can be adopted. Further, the peripheral shape of the plug main body 1 is left-right or top-bottom asymmetric, so that no polarity-confused insertion into the terminal ports, formed in the same shape as it, will occur.

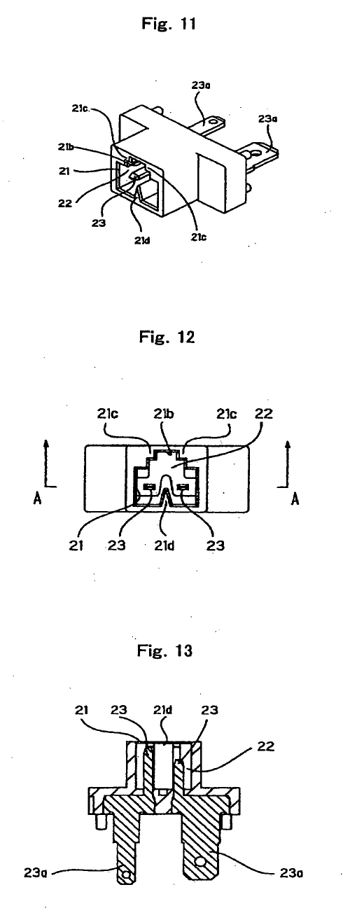

A locking lever 4 is configured on the top surface of the front end of the front portion 1a of the plug main body 1, it has the locking function for holding the plug main body 1 by locking its insertion end when the plug is inserted into a terminal port configured with the speaker terminal described with respect to FIG. 11 to FIG. 13 later. The pointed end portion 4a of the locking lever 4 is formed as a whole with the front portion 1a of the plug main body 1, and the lever main body 4b in the shape of a bent lever with springiness is formed next to the back end of the pointed end portion 4a. The lever main body 4b has a approximate T shape as seen from plane which is formed toward the inserted direction of the plug main body 1, and convex portions formed respectively on the left side surface and the right side surface of the middle portion of the locking lever 4 function as locking parts 4c for being hooked and locked into stop shoulders (locking convex portions) in the terminal port of the speaker terminal described later.

At the inside of the plug main body 1, the 5a, 5b are terminal holding tongue pieces corresponding to the left and right two terminal insertion ports 2, they are configured on the top side and the bottom side respectively, and the 6a, 6b are cable holding tongue pieces corresponding to the left and right two cable insertion ports 3, they connect with the terminal holding tongue pieces 5a, 5b respectively and are configured on the top side and bottom side respectively at the inside of the back portion 1b of the plug main body 1. The respective pieces 5a with 6a, the pieces 5b with 6b are electrically connected.

In addition, the pieces 5a and 6a, the pieces 5b and 6b can be arbitrarily formed as a whole or separately formed. Further, the pieces 5a, 6a and 5b, 6b are electrically isolated from each other between two poles.

In addition, there forms a narrow portion 51 between the terminal holding tongue pieces 5a and 5b, it is narrowed in the shape of a taper towards the front end of the pieces so that the front end of the two pieces can simultaneously press and hold a inserted terminal from top side and bottom side respectively by springiness from their material.

On the other hand, among the left and right cable holding tongue pieces 6a, 6b located on the same axis with the left and right two cable insertion ports 3 of the back portion of the plug main body, the piece 6a is formed to a springiness body in an approximate hairpin shape. On the other hand, another piece 6b is integrated with the terminal holding tongue piece 5b electrically and mechanically, but it has a contact part 61b for sticking up a contacting portion with a cable.

The 7 is an operating piece for resisting the piece 6a in a pressed down state at all times by its springiness and deforming the piece 6a towards upside, and it is in a approximate quadrangle plate shape here. The front end (left lower end in FIG. 9 and FIG. 10) of the operating piece 7 is configured with a operating part 7a for pressing down (pushing up in FIG. 9 and FIG. 10) the operating piece 7, which is formed so as to stand out to the outside of the plug main body 1 from the bottom side of the plug main body 1 (with reference to FIG. 9 and FIG. 10). And the 7b is a joint part of the operating piece 7 with the end 6a of the cable holding tag 6a, the 7c is a stall wall formed by the operating piece 7.

While the description above is given with respect to the constructions of the terminal insertion port 2 and the cable insertion port 3 for one pole in the cable plug of the invention, the terminal insertion port 2 and the cable insertion port 3 for another pole have the same construction as above respectively. Consequently, two operating pieces 7 joint respectively with the ends 6a of the two cable holding tongue pieces 6a for two pole cables on the respective approximately same axis as those of the two cable insertion ports 3 configured in the plug main body 1. That is, two operating pieces 7 in the same form are configured at the middle portion within the plug main body 1 in parallel, and the respective operating parts 7a of the two operating pieces 7 standing out of the plug main body 1 comprise respectively a press part 7d towards an opposite direction to another as shown in FIG. 1˜FIG. 4, and can operate separately by pressing the respective press part 7d. By the way, if the two operating parts 7a are integrated to connect with each other, the two cable holding tongue pieces 6a for two pole cables will be expanded simultaneously when the integrated operating part 7a is pressed down (pushed up in Figs).

In general, there would be no particular problem even if two cable holding tongue pieces 6a for two poles are expanded simultaneously since, while not shown, the speaker cables of two poles are twisted wires with same size. However, if the operating parts 7a for the two holding pieces 6a are integrated as a whole, it is difficult to enable a suitable holding strength to be applied to the thinner cable among the twisted wires for two poles when one of the twisted wires is thinner than another due to the defect of their coat-flaked off portion or when the thicknesses of the cables are different.

Therefore, in the invention, each operating part 7a of the two operating pieces 7 set respectively for the two cable holding tongue pieces 6a for two poles is so formed with the press part 7d that it can operate separately at the corresponding side, so the holding strengths of the cable holding tongue pieces 6a on the cables for positive and negative poles function separately even if there is a difference in thicknesses of the cables for the two poles as above. This is described below with reference to FIG. 1 to FIG. 4.

As shown in FIG. 1 to FIG. 4, the press parts 7d are formed in a curved shape outward from each other respectively in the operating parts 7a of the two operating pieces 7. It makes possible, for the cables inserted into the two cable insertion ports 3 for respective poles, to operate various cable holding tongue pieces 6a separately by operating the press part 7d corresponding to the cable for the respective pole by the configuration of the two press parts 7d. Thus, it is possible to implement without hindrance the operation for connecting the cables for respective poles with the plug of the invention even if there is a difference on the diameters of the twisted wires for two poles, the difference on thicknesses among the speaker cables.

The mode of the cable w connecting with the speaker cable plug of the invention formed as above is described with reference to FIG. 9 and FIG. 10. FIG. 9 shows the internal condition of the speaker cable plug of the invention before connecting with the cable w, wherein the two operating pieces 7 (only one can be seen in FIG. 9) are in the state that they are pressed towards the underside of the plug main body 1 by springiness from corresponding cable holding tongue pieces 6a. At this point, the poses of the two operating pieces 7 are same as that shown in FIG. 1, FIG. 4.

Under the state, when the cable w for one pole, of which the twisted wire w2 comes out after the coat w1 of the portion connecting with the speaker cable plug was removed, inserts through one of the insertion ports 3 of the plug main body 1, the press part 7d of the operating part 7a of the corresponding one of the two operating pieces 7 need to be pushed up by finger, then the tongue piece 6a expanded by springiness is held up at the joint part 7b, then the twisted wire portion w2 of the cable w is inserted into the in-depth end of the plug main body 1 through the cable insertion port 3. At this insertion, the twisted wire w2 does not suffer the resistance of the tongue piece 6a. In addition, the front end of the coat w1 of the cable w will be prevented from entering into by the narrow inlet 3a of the insertion port 3 during the insertion. Moreover, the front end of the bare twisted wire w2 is prone to enter more deeply towards the front end of the plug main body 1 thereby likely to contact with the adjacent terminal with an opposite polarity when the twisted wire w2 portion is too long. In the invention, as the means for preventing from such a short circuit, there configured a stop 1c at the boundary portion of the front portion 1a and the back portion 1b in the plug main body 1, and stall walls 7c are formed on the operating piece 7 as short-circuit preventing mechanisms.

Once the twisted wire w2 of the cable w is inserted into a specified location in the plug main body 1, the front end 61a of the cable holding tongue piece 6a jam into the top surface of the twisted wire w2 by springiness and the bottom surface of the twisted wire w2 is pressed to connect with the contact part 61b of the cable holding tongue piece 6b by springiness above when withdrawing the finger from the operating part 7a ever pushed up by the finger. At this time, the front end 61a of the tongue piece 6a and the contact part 61b of the tongue piece 6b function as a drawing-out-stopping part for drawing out means since both of them incline along the insertion direction of the twisted wire w2. Thus, the connection state that the cable w for one pole is combined electrically and mechanically with the speaker cable plug of the invention in the manner shown in FIG. 10 is achieved.

While the description above illustrated the case in which the cable w for one of the poles is connected to the speaker cable plug of the invention, the cable for another pole also can be held by the cable holding tongue pieces for the another pole formed in the plug main body 1 to connect with them completely the same as the cable w.

Further, while the speaker cable plug of the invention described with respect to FIG. 1 to FIG. 4, FIG. 9 and FIG. 10 is a speaker cable plug for one channel, namely a speaker cable plug for positive and negative two poles of one channel, the plug of the invention also can be formed by manufacturing the plug main body 1 with a configuration for connecting with four cables of two channels in the integrative formation mode described above. While not shown, it is possible to form integrally the plug main body 1 to connect with cables for three channels or more as above. The plug main body 1 can be formed for any number of channels.

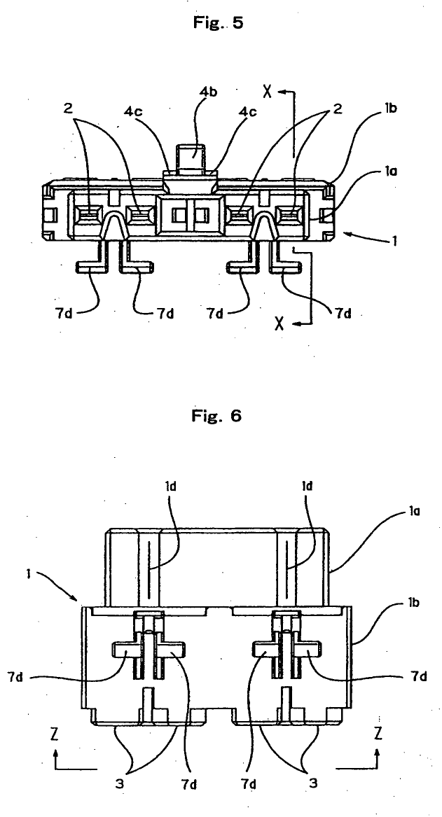

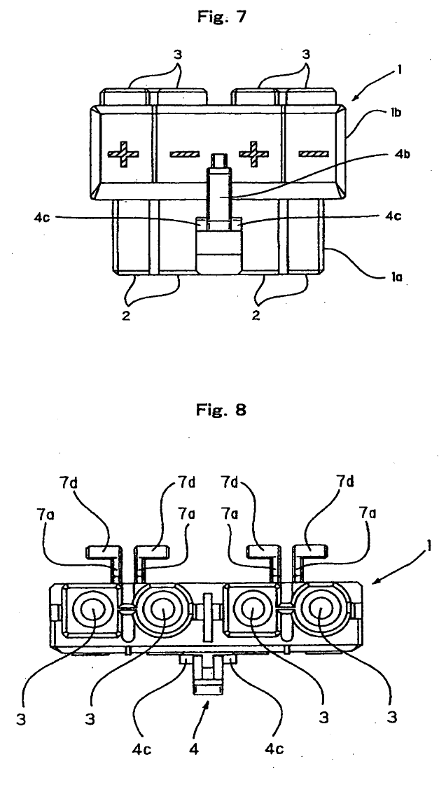

As shown in FIG. 5 to FIG. 8, the entire configuration of the speaker cable plug and the operation are simplified due to it is sufficient to configure the locking lever 4 functioning to prevent the speaker cable plug from being drawn out in relative to terminal ports of a speaker terminal at one location, the centre portion of the plug main body 1 seen from its face. In addition, in FIG. 5˜FIG. 8, the same parts and portions as those in FIG. 1 to FIG. 4, FIG. 9 and FIG. 10 are designated by the same reference numerals.

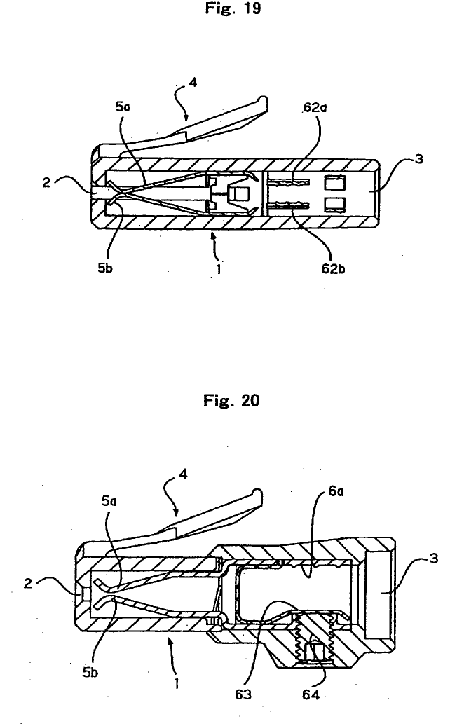

The speaker cable plug for multiple channels in which the locking lever 4 described above is configured at one location, the centre portion, also can be applied to the plug with the configuration illustrated in FIG. 19 and FIG. 20. The example of FIG. 19 is a plug in which the crimping-holding parts 62a, 62b for twisted wire W2 are formed by extending and forming integrally the second half portion of the terminal holding tongue pieces 5a, 5b and the twisted wire W2 is sandwiched between the crimping-holding parts 62a and 62b and those are crimped.

FIG. 20 shows a plug in which the crimping piece 63 with springiness is configured on the side of the cable holding tongue piece 6b, and the twisted wire w2 inserted is pressed to the side of the holding tongue piece 6a in plate form configured on the top surface and held by pushing up the crimping piece 63 by the screw 64.

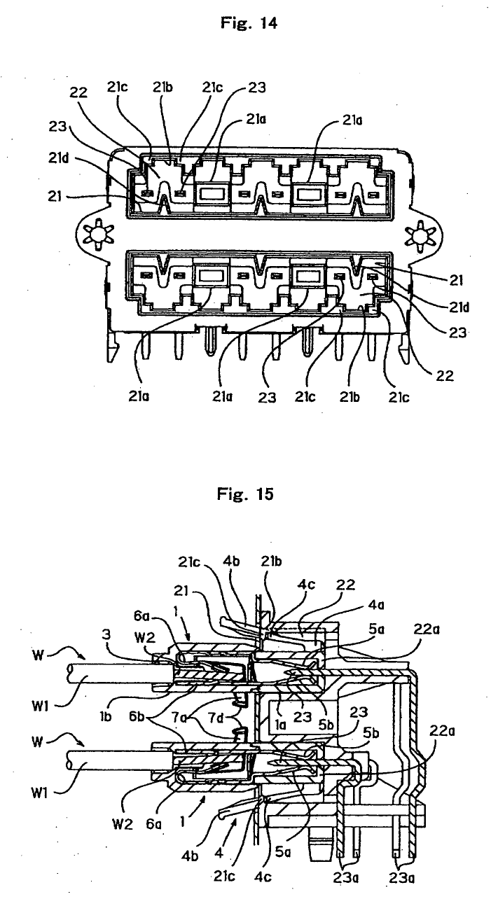

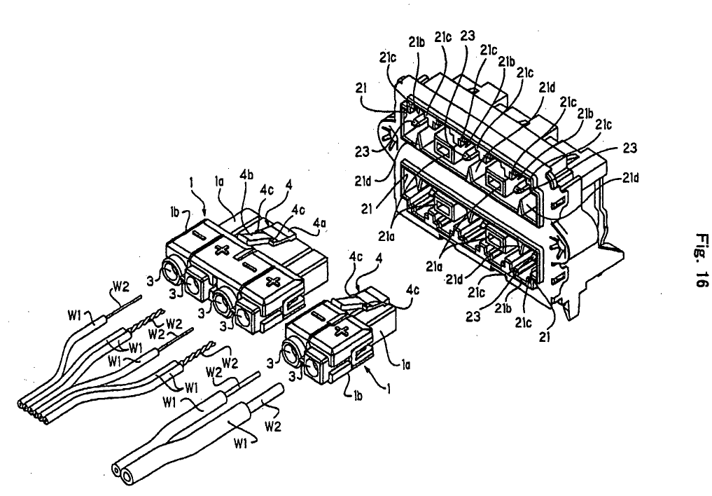

In the plugs of FIG. 19, FIG. 20, it also can be the case that the plug main body 1 is formed integrally for two channels and one locking lever 4 is configured at the centre portion of the plug main body 1 formed integrally. In addition, the speaker terminal of FIG. 18 comprises the opening portion 21 and the terminal ports 22 of which shape correspond to the shape of the plug main body 1 formed integrally for multiple channels. In addition, in FIG. 18, the same parts and portions as those in FIG. 14 to FIG. 16 are designated by the same reference numerals.

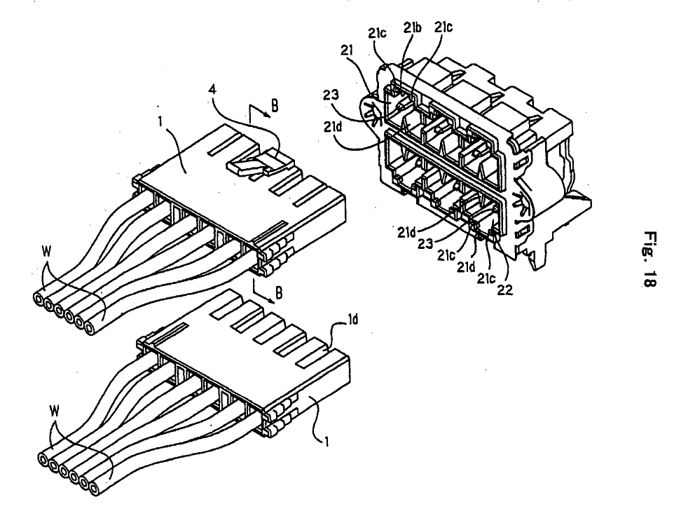

Next, the speaker terminal according to an embodiment of the invention which can be inserted by the speaker cable plug of the invention as above will be described with reference to FIG. 11 to FIG. 13 and FIG. 14 to FIG. 17.

FIGS. 11 to 13 show an example of a speaker terminal for single channel.

In FIG. 11 to FIG. 13, the 21 is an opening portion of the speaker terminal according to the invention, of which cross-section shape of inner circumference is same approximately as the face cross-section shape of the plug main body 1 containing the front portion 1a and the front end 4a of the locking lever 4 integrated with the front portion 1a in the plug for single channel of the invention described with reference to FIG. 1 to FIG. 4 above, the opening portion 21 is depressed continuously from the opening portion 21 towards in-depth end thereof in the straight cross-section shape of the opening portion 21 so as to become the shape of a box, thereby forming the terminal port 22. The contacting piece 23 of the speaker terminal, which is held from upside and underside thereof by the speaker terminal holding tongue pieces 5a, 5b of the speaker cable plug of the invention described above, are configured on the erect wall 22a at the in-depth end of the terminal port 22 in a horizontal state towards the opening portion 21. As illustrated in FIG. 11 and FIG. 12, positive contacting piece 23 and negative contacting piece 23 are configured in a horizontal state in parallel at the inside of the terminal port 22. In addition, as shown in FIG. 13, the positive contacting piece 23 and the negative contacting piece 23 are so formed that the front end of the positive contacting piece 23 locates more deeply at the in-depth end of the opening portion 21 in relative to the negative contacting piece 23, so as to prevent from the noise at plug connecting time. Further, a test finger does not contact the contacting pieces 23 owing to the location of the contacting pieces 23 and the face shape of the opening portion 21 described below. The 23a are connecting pieces integrated with the positive contacting piece 23 and the negative contacting piece 23, and they are connected to the output circuit of an amplifier or input terminals of a speaker.

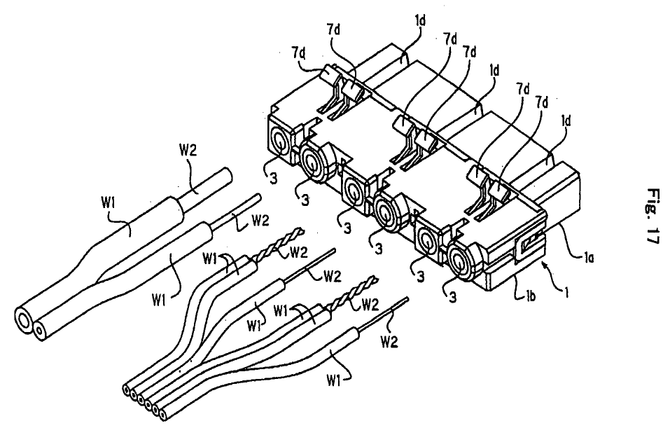

On the other hand, FIG. 14 and FIG. 16 show an example of a speaker terminal for multiple channels, and the 21 is an opening portion in another example of the speaker terminal according to the invention, which is formed by juxtaposing breadthways three of the opening portion for the plug main body 1 for single channel with the cross-section shape of inner circumference approximately same to the face cross-section shape of the plug main body 1 for single channel containing the front portion 1a and the front end 4a of the locking lever 4 integrated with the front portion 1a and spacing them in two spacer block parts 21a. The opening portion 21 for the three plug main bodies 1 for single channel, which is in the straight cross-section shapes of the front portions 1a of the plug main bodies 1, is configured with two separate spacer lock parts 21a and depressed continuously from the opening portion 21 towards in-depth end thereof so as to become the shape of a box, thereby forming the terminal port 22 for the speaker cable plug of the invention formed by three plug main body 1 integrally. The contacting piece 23 of the speaker terminal, is held from upside and underside by the speaker terminal holding pieces 5a, 5b of the plug of the invention described above, are configured on the erect wall 22a at the in-depth end of the terminal port 22 in a horizontal state towards the opening portion 21 respectively for respective channels. Three groups of contacting pieces 23 (for three channels), each group comprising a positive contacting piece 23 and a negative contacting piece 23, are configured in the terminal port 22 for the three plug main bodies described above in a horizontal state in parallel.

In addition, in the another example of the speaker terminal of the invention in FIG. 14, FIG. 16, the positive contacting pieces 23 for various channels and the negative contacting piece 23 for various channels are so formed that the front end of the positive contacting pieces 23 locate more deeply at the in-depth end of the opening portion 21 in relative to the negative contacting pieces 23, so as to prevent from the noise at plug connecting time. Further, as the case of the speaker terminal in FIG. 11 to FIG. 13, a test finger does not contact the contacting pieces 23 owing to the location of the contacting pieces 23 and the face shape of the opening portion 21. The 23a are connecting pieces integrated with the positive contacting pieces 23 and the negative contacting pieces 23.

The top half portion of the opening portion 21 configured on the topside of the speaker terminal of the invention illustrated in FIG. 14, which can be inserted by the plug main body 1 capable of connecting with cables for three channels, is in the face-projecting-appreciably shape corresponding to the cross-section shape of the front portion 1a and the front end 4a of the locking lever 4 in one inserted plug main body 1 shown in FIG. 1 to FIG. 4, and the opening portion comprising concave portions 21b corresponding respectively to the lever main body 4b of the locking lever 4 in the plug main body 1 shown in FIG. 1 to FIG. 4 and the convex portions 21c (locking convex portions) respectively for locking the locking part 4c formed in the lever main body 4b described above is formed in parallel laterally with three opening portion in FIG. 11 to FIG. 13 by interposing the spacer lock parts 21 among them, thereby forming the another example of the speaker terminal of the invention for three channels shown in FIG. 14, FIG. 16.

In the case that the speaker terminal of the invention for multiple channels is used as a output terminal for a speaker in an amplifier etc., since the terminal port 22 for the speaker terminal corresponding to the cable plug for three channels is formed on the topside in the example of FIG. 14, FIG. 16, and the opening portion 21 and the terminal port 22 continuing with the opening portion 21 are formed up-down symmetrically, so the speaker terminal which can be inserted by the plug for six channels is formed. As illustrated in FIG. 14, FIG. 16, in the speaker terminal of the invention configured in an amplifier etc. as a output terminal to six speakers for 5.1 channels described at the beginning, up-down symmetrical two-group opening portions 21 and terminal ports 22 continuing with the opening portions 21 are formed in terminal blocks.

In the case of as a output terminal for speakers in an audio output device such as DVD player, depending on the number of channels, the speaker terminal of the invention described above can be formed in various mode from for at least two channels (two terminal ports 22) to comprising multiple terminal ports 22 in the same shape as the opening portion 21 corresponding to arbitrary number of channels.

On the other hand, in the case of as an input terminal for speakers in a speaker box etc., as shown in FIG. 11 to FIG. 13, the speaker terminal of the invention also can comprise as least one terminal port 22 having the opening portion 21 and the contacting pieces 23. Even if there are multiple channels, the speaker terminal of the invention as above can be configured to function regardless of as an output terminal or an input terminal by only differentiating the number of terminal ports 22 comprising the opening portion 21 and contacting pieces 23, and the terminal mode for single channel there into is same.

In the example of the speaker terminal of the invention described above, the convex shape portion 21d in an approximate hill shape is formed at the side not configured with the concave portion 21b and the convex portions 21c in the opening portion 21. The convex shape portion 21d can further prevent a test finger from contacting the contacting pieces 23 by functioning as a guide of a plug inserting operation and a drawing out operation but the reversed insertion operation in up-down direction of the plug since it corresponds the vale portion 1d (with reference to FIG. 1, FIG. 6) with a V shape, which is configured at the side corresponding to the plug main body 1 (the bottom wall side in FIG. 2).

The condition that the plug of the invention is inserted into the speaker terminal configured as above is described as follow with reference to FIG. 15. Firstly, aligning the front end of the front portion 1a of the plug main body 1 is with the opening portion 21 of the speaker terminal of the invention and inserting it towards the in-depth end of the terminal port 22 straightly. At this time, since, until the locking part 4c passed the convex portions 21c, it is pressed downwards by the convex portions 21c of the opening portion 21, the lever main body 4b of the locking lever 4 deforms downwards by springiness to bend and insert into. However, when the locking part 4c of the lever main body 4b passed the convex portions 21c, the bend rebound instantly owing to the back portion of the lever main body 4b entered the concave portion 4b in a moment since the lever main body 4b become thinner behind the locking portion 4c, and at this time, a table tone is delivered to the fingers and ears of the operator as the click feel of the plug insertion completed. As a result, the locking part 4c is connected and hooked entirely into the inside of the convex portions 21c, thereby the plug can not be drawn out.

In drawing out the plug of the invention described above from the terminal port 22, it is needed to take the state that the back end of the locking lever 4 is pressed by a finger and the locking part 4c is made capable of getting across the convex portions 21c from inside thereof, and under the state, the plug can be drawn out.

In the speaker terminal of the invention described above, it is desired to separate in color the edges or peripheries of various opening portions in order to prevent from misconnection among channels. In addition, various opening portions 21 can be stuck with a shield board (not shown) at a configured panel for dealing with noise of digital equipments.

The invention has been described as above, in the speaker cable plug of the invention, each speaker cable for a respective pole can be inserted into or drawn out and connected with the plug by a holding strength corresponding to the thickness of its leading wire even if it is the case that the thicknesses of leading wires for positive pole and negative pole are different among the speaker cables, owing to the configuration that each speaker cable for a respective pole can be inserted into the plug or drawn out from it by one touch operation. In addition, in the plug of the invention, owing to the configuration comprising one locking lever in the shape of a bent lever with springiness in the plug formed by integrating the plug main bodies of two or more channels, the connection to a speaker terminal for two or more channels can be conformed depending on a moderation feel in once operation inserting the plug connecting with cables for multiple channels by engaging the convex portions of the terminal with the locking part of one locking lever of the plug and keep the state that the plug can not be drawn out straightly, and the plug for multiple channels can be drawn out by one operation if only pressing the one lever when drawing out it, therefore, the plug for multiple channels can not be drawn out by error resulted in a outer force. Further, it makes possible to implement space-saving configuration of the speaker terminal for multiple channels as a result of the cable plug formed by integrating the plug main bodies of two or more channels.

On the other hand, the speaker terminal that the plug described above can be inserted into or drawn out is formed in up-down or left-right asymmetrical cross-section in order to prevent from polarity-confused insertion by the plug, the space efficiency is optimized and the speaker terminal for multiple channels can be formed in a small space owing to its left-right symmetrical configuration in channel. There is no problem on utility even if the speaker terminal for multiple channels is configured in a small space since it is separated in color for each channel and configured with a shield board for dealing with noise in order to prevent from misconnection.

What is claimed is:

1. A speaker cable plug characterized in that a plug main body is internally hollow and formed with a terminal insertion port for positive and negative electrodes in the front surface, and with a cable insertion port corresponding to the both electrodes in the rear surface, and which internally has terminal holding tongue pieces for holding a speaker terminal inserted through the terminal insertion port from both sides of the speaker terminal by springiness respectively, and cable holding part connected to the terminal holding tongue pieces respectively for holding the lead wires of the speaker cable for positive and negative electrodes inserted through the cable insertion port from both sides of the lead wires by springiness,
wherein an operating piece for expanding the cable holding parts of the cable holding tongue pieces for both electrodes is formed so that each cable holding part can be expanded by a separate operating piece independently.

2. The speaker cable plug of claim 1, wherein the plug main body is configured with a locking lever having a locking part, on external surface of the side configured with the terminal insertion port, which is pressed bend at an inlet of the terminal port and locked into the inlet of the terminal port due to its rebounding by springiness as passed the inlet, when the plug main body is inserted into a terminal port of an amplifier having a speaker terminal internally.

3. The speaker cable plug of claim 1 or 2, wherein the plug main body comprises terminal insertion ports and cable insertion ports for at least two channels and internal configurations each configured between the terminal insertion ports and the cable insertion ports for a respective channel among the channels, and the terminal insertion ports, the cable insertion ports and the internal configurations for at least two channels are formed as a whole.

4. The speaker cable plug of claim 3, wherein the locking lever of claim 2 is configured by one in the plug main body of claim 3 comprising cable connection configurations and terminal connection configurations for at least two channels.

5. A speaker cable plug characterized in that the plug main body is internally hollow and formed with a terminal insertion port for positive and negative electrodes in the front surface, and with a cable insertion port corresponding to the both electrodes in the rear surface, and which internally has terminal holding tongue pieces for holding a speaker terminal inserted through the terminal insertion port from both sides of the speaker terminal by springiness respectively, and cable holding part connected to the terminal holding tongue pieces respectively for holding the lead wires of the speaker cable for positive and negative electrodes inserted through the cable insertion port from both sides of the lead wires by springiness, wherein
the plug main body comprises terminal insertion ports and cable insertion ports for at least two channels and internal configurations for the various channels, and the terminal ports, the cable insertion ports and the internal configurations for the at least two channels are formed as a whole.

6. The speaker cable plug of claim 5, wherein the plug main body is configured with a locking lever having a locking part, on external surface of the side configured with the terminal insertion port, which is pressed bend at an inlet of the terminal port and locked into the inlet of the terminal port due to its rebounding by springiness as passed the inlet, when the plug main body is inserted into a terminal port of an amplifier having a speaker terminal internally.

7. The speaker cable plug of any one of the claims from claim 1 to 6, further being formed so that no polarity confusion occurs during its insertion into a terminal port owing to the left-right or up-down asymmetric front cross-section shape of the plug main body.

8. A speaker terminal, comprising terminal ports in the form of a straight depression towards in-depth end along an opening portion which forms an opening, on the front-end surface of the speaker terminal, in the cross-section shape approximately same to the front cross-section peripheral shape of a plug main body which is formed as a whole so as to be able to connect with inserted speaker cables of at least two channels, and
contacting pieces of the terminals for both electrodes for a speaker of each channel, which are configured respectively, in a approximately horizontal attitude towards front end-surface of the opening portion, on the in-depth inner-wall surface of the terminal ports, and wherein
locking convex parts for hooking and holding locking parts of locking levers of an inserted plug main body are formed at the opening edge of the front-end of the terminal ports.

9. The speaker terminal of claim 8, wherein the contacting pieces of both electrode terminals for the speaker are formed so that the there is a difference in distance relative to the front end-surface of the opening portion between the leading edges of the contacting pieces.

10. The speaker terminal of claim 8 or 9, wherein the speaker terminal comprising speaker terminal ports for at least two channels is formed so that terminal ports for paired channels have symmetric configurations.

11. The speaker terminal of any one of the claims, claim 8 to claim 10, wherein the external surface of the front-end of the terminal port for each channel are colored up in every channel.

12. The speaker terminal of any one of the claims, claim 8 to claim 11, further a shield board is configured on the front surface excluding each of the terminal ports.

13. A speaker terminal system, comprising the speaker cable plug of any one of the claims, claim 1 to claim 4 and claim 7 or the speaker cable plug of any one of the claims, claim 5 to claim 7, and the speaker terminal of any one of the claims, claim 8 to claim 12 in a set.
